(19) United States
(12) Patent Application Publication
(10) Pub. No.: US 2014/0082752 A1
(43) Pub. Date: Mar. 20, 2014

(54) Read-Once Data Sets and Access Method

(71) Applicant: INTERNATIONAL BUSINESS MACHINES CORPORATION, Armonk, NY (US)

(72) Inventors: Dustin A. Helak, Tucson, AZ (US); David C. Reed, Tucson, AZ (US); Thomas C. Reed, Tucson, AZ (US); Max D. Smith, Tucson, AZ (US)

(73) Assignee: INTERNATIONAL BUSINESS MACHINES CORPORATION, Armonk, NY (US)

(21) Appl. No.: 13/621,491

(22) Filed: Sep. 17, 2012

(51) Int. Cl. G06F 21/24

(52) U.S. Cl. 726/30

(57) ABSTRACT

A documentation inventory manager provided which ensures that a client data set may only be read once. More specifically, the documentation inventor manager comprises a data set type and an access module. In certain embodiments, the data set type is only created once and can only be accessed via the read once access module. The read once access module ensures on read, that the data which was read is no longer readable. In various embodiments after being read once the data is automatically corrupted, deleted, or overwritten.

### BACKGROUND OF THE INVENTION

1. Field of the Invention

The present invention relates in general to the field of computer operations and, more particularly to a remote inventory manager for use with computer operations.

2. Description of the Related Art

Often in the area of information technology (IT) information and data is shared. For example, people and businesses may provide personal and private information and data to a third party for various reasons (e.g., for credit card transactions, private emails, system logs, password resets, etc). Often the provided information is necessary to complete a single transaction. When the need for that data has ended, the client who initially provided the data has no reliable way to confirm whether their data has been deleted, no reliable control over when that data is deleted and no reliable control over whether the information is viewed by an entity other than the original recipient. For example, when a company requests documentation from a client to diagnose a problem, the client may provide items like memory storage dumps. These storage dumps often contain proprietary or confidential information. Clients often hesitate to provide this information, because the client cannot be assured that the information will be handled and disposed of properly. Accordingly, it is desirable to provide an ability to allow an audit of the information to ensure that a client's data is handled and disposed of properly.

For example, in known systems, when clients provide information, the information is often stored on a common server. Different individuals or groups of the receiving company can access the data from that server. Businesses and positions that receive personal, private, or discreet information do their best to ensure clients data is kept private. However, one known solution to ensure this privacy typically include a storage management system to remove the data after a certain amount of time has expired. This solution allows for the data to be read and copied numerous times prior to its eventual removal. However, the client that provided the data cannot ensure that this data was never used more than once by the recipient.

### SUMMARY OF THE INVENTION

In accordance with the present invention, a documentation inventory manager is provided which ensures that a client data set may only be read once. More specifically, the documentation inventor manager comprises a data set type and an access module. In certain embodiments, the data set type is only created once and can only be accessed via the read once access module. The read once access module ensures on read, that the data which was read is no longer readable. In various embodiments after being read once the data is automatically corrupted, deleted, or overwritten. Accordingly, by using this documentation inventory manager, clients can send and share data with a third party while ensuring that the recipient can only view the data once and that the data is removed after it is read. This documentation inventory manager provides an added level of security for ensuring private data is only viewed and/or used once.

More specifically, in one embodiment the present invention relates to a method for managing access to information provided by a client to an entity. The method includes: providing the information from the client to the entity via an access module; ensuring, via the access module, that the information is only created once at a storage location of the entity; after the information is accessed by the entity, configuring the information within the storage location to be no longer be readable.

In another embodiment the present invention relates a system including a processor, a data bus coupled to the processor; and a computer-usable medium embodying computer program code. The computer-usable medium is coupled to the data bus, the computer program code and comprises instructions executable by the processor and configured for: providing the information from the client to the entity via an access module; ensuring, via the access module, that the information is only created once at a storage location of the entity; and, after the information is accessed by the entity, configuring the information within the storage location to be no longer be readable.

In another embodiment, the present invention relates to a computer-usable medium embodying computer program code, where the computer program code comprises computer executable instructions configured for: providing the information from the client to the entity via an access module; ensuring, via the access module, that the information is only created once at a storage location of the entity; and, after the information is accessed by the entity, configuring the information within the storage location to be no longer be readable.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an exemplary computer system in which the present invention may be implemented.

FIG. 2 shows a flow chart of the operation of a documentation inventory manager.

FIG. 3 shows a flow chart of the operation of an access module.

### DETAILED DESCRIPTION

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

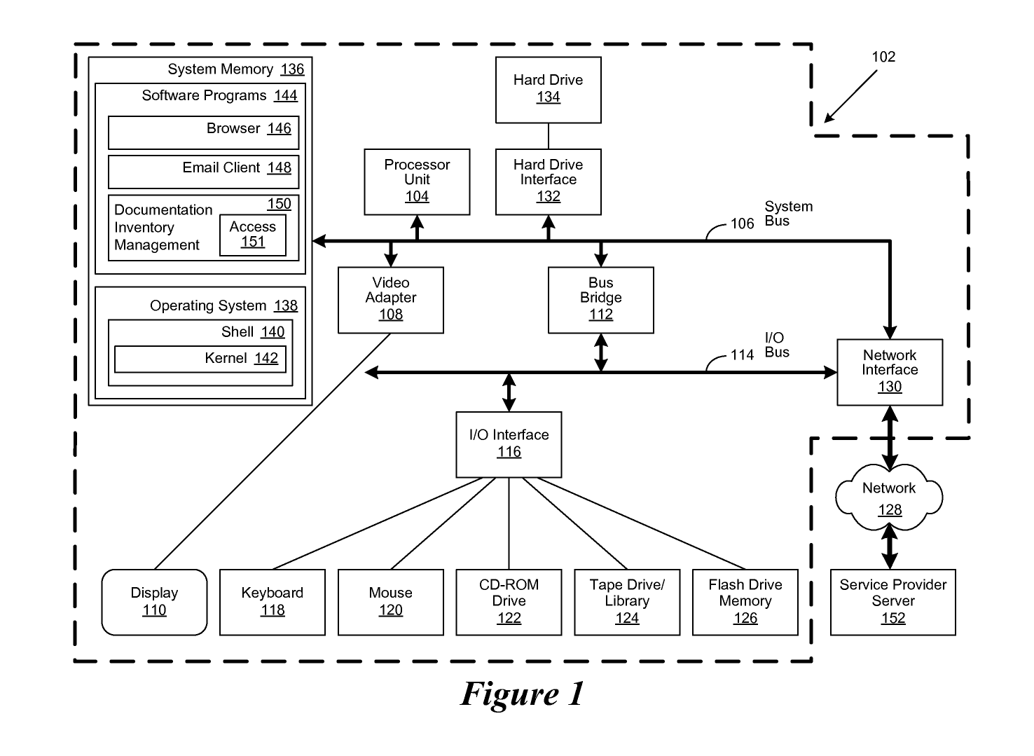

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk—Read Only Memory (CD-ROM) drive 122, a tape drive 124 (which may include one or a plurality of tapes to provide a library), and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

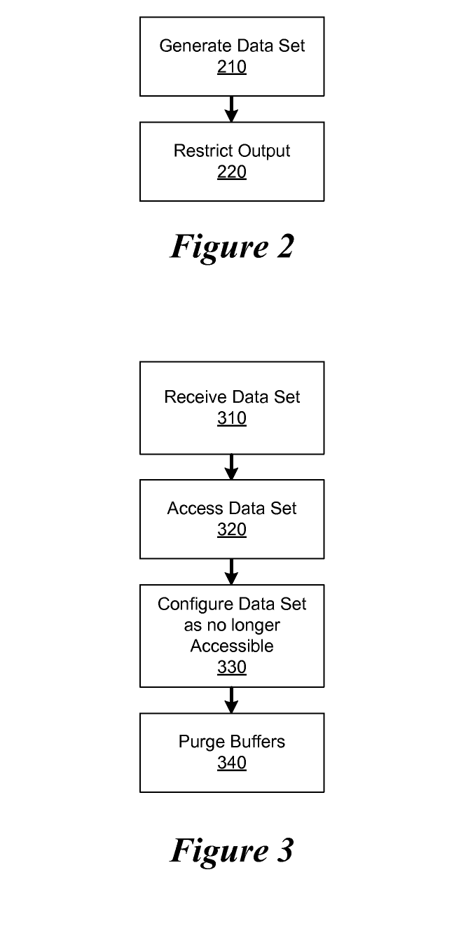

Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include a documentation inventory manager module 150 and an access module 151 (which in certain embodiments may be included within the documentation inventory manager module. The documentation inventory manager module 150 and access module 151 include code for implementing the processes described in FIGS. 2-3 described hereinbelow. In one embodiment, client computer 102 is able to download the documentation inventory manager module 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

Referring to FIG. 2, a flow chart of the operation of the documentation inventory manager 150 is shown. More specifically, a data set is generated using the access module 151 at step 210. The data set comprises encrypted data which can only be read and written by the read once access module of the documentation inventory manager 150. The data set includes a sequential file that is encrypted by an encrypter on the sending side and is decrypted by the access module 151 on the receiving end. The access module 151 provides the decryption function. A security application (such as a resource access control facility (RACF)) controls who has access to the access module 151. Each instance of the access module 151 can utilize known public/private key combinations if further security is required. The access module 151 ensures that the data set is deleted as the data set is being read.

This access module 151 encrypts the data on creation thus ensuring that the data can only be read using the access module 151. Because the data is only readable via the access module 151, the access module 151 also restricts output from being sent to unknown writers (thus ensuring data won't be sent to a new file) at step 220. Also by encrypting the data via the access module 151, additional security is provided to the data to ensure that any copy of the storage containing this data to a new dataset will only provide encrypted data that is unreadable by anything other than the access module 151.

Referring to FIG. 3, a flow chart of the operation of the access module 151 is shown. More specifically, the access module 151 ensures that any type of access (e.g., a read) of this data performs a remove operation of that data. As an example, when a user is sent sensitive documentation such as a password or bank account information, the access method encrypts the data as it is received on the target system. More specifically, at step 310 an end user receives data provided by a client. The end user accesses the data via the access module 151 at step 320. After the end user opens the file via the access module 151, the file is then configured to be no longer readable on exit at step 330 and associated buffers are purged at step 340. Additionally, in certain embodiments, portions of the file are deleted by the access module 151 as a user scrolls through the contents of the file.

Removal of data can be performed using a plurality of methods, any of which ensure the data that was previously stored in that area are no longer readable by the system. More specifically the data may be removed by replacing the data with random bytes essentially corrupting the data. Alternately, the data may be removed by zeroing out all the data that was read. The access module 151 could also create a channel command at the hardware micro-code level (e.g., something on the level of a “read-and-delete” instruction. One that will return the requested data, and scratch that data on a hardware level so that it is no longer readable.

Additional levels of security could be added to ensure the data is not copied or compromised using tools such as a resource access control facility (RACF) to prevent unauthorized tools from touching the data, or even adding additional encryption forcing the data to be viewed only through an authorized viewer program.

Although the present invention has been described in detail, it should be understood that various changes, substitutions and alterations can be made hereto without departing from the spirit and scope of the invention as defined by the appended claims.

What is claimed is:

1. A method for managing access to information provided by a client to an entity, the method comprising:
providing the information from the client to the entity via an access module;
ensuring, via the access module, that the information is only created once at a storage location of the entity; and,
after the information is accessed by the entity, configuring the information within the storage location to be no longer be readable.

2. The method of claim 1, wherein
the information provided to the entity corresponds to a data set type.

3. The method of claim 1, further comprising
encrypting the information provided from the client to the entity before providing the information to the entity; and,
storing the encrypted information to the storage location of the entity via the access module; and wherein
access to the encrypted information is only via the access module.

4. The method of claim 1, wherein
configuring the information to be no longer readable comprises at least one of corrupting the information, deleting the information and overwriting the information within the storage location.

5. The method of claim 1, wherein
the access module provides security to ensure the information is not copied after the information has been stored to the storage location of the entity.

6. The method of claim 5, wherein
the access module interacts with a resource access control facility (RACF) to prevent unauthorized tools from accessing the information.

7. A system comprising:
a processor;
a data bus coupled to the processor; and
a computer-usable medium embodying computer program code, the computer-usable medium being coupled to the data bus, the computer program code comprising instructions executable by the processor and configured for:
providing the information from the client to the entity via an access module;
ensuring, via the access module, that the information is only created once at a storage location of the entity; and,
after the information is accessed by the entity, configuring the information within the storage location to be no longer be readable.

8. The system of claim 7, wherein
the information provided to the entity corresponds to a data set type.

9. The system of claim 7, wherein the computer program code further comprises instructions executable by the processor and configured for:
encrypting the information provided from the client to the entity before providing the information to the entity; and,
storing the encrypted information to the storage location of the entity via the access module; and wherein
access to the encrypted information is only via the access module.

10. The system of claim 9, wherein
configuring the information to be no longer readable comprises at least one of corrupting the information, deleting the information and overwriting the information within the storage location.

11. The system of claim 7, wherein
the access module provides security to ensure the information is not copied after the information has been stored to the storage location of the entity.

12. The system of claim 11, wherein
the access module interacts with a resource access control facility (RACF) to prevent unauthorized tools from accessing the information.

13. A computer-usable medium embodying computer program code, the computer program code comprising computer executable instructions configured for:
providing the information from the client to the entity via an access module;
ensuring, via the access module, that the information is only created once at a storage location of the entity; and,
after the information is accessed by the entity, configuring the information within the storage location to be no longer be readable.

14. The computer-usable medium of claim 13, wherein
the information provided to the entity corresponds to a data set type.

15. The computer-usable medium of claim 13, wherein the computer program code further comprises instructions executable by the processor and configured for:
encrypting the information provided from the client to the entity before providing the information to the entity; and,
storing the encrypted information to the storage location of the entity via the access module; and wherein
access to the encrypted information is only via the access module.

16. The computer-usable medium of claim 15, wherein
configuring the information to be no longer readable comprises at least one of corrupting the information, deleting the information and overwriting the information within the storage location.

17. The computer-usable medium of claim 13, wherein
the access module provides security to ensure the information is not copied after the information has been stored to the storage location of the entity.

18. The computer-usable medium of claim 17, wherein
the access module interacts with a resource access control facility (RACF) to prevent unauthorized tools from accessing the information.
